(19) United States
(12) Patent Application Publication
(10) Pub. No.: US 2017/0191584 A1
(43) Pub. Date: Jul. 6, 2017

(54) POLYMER PIPING ASSEMBLY

(71) Applicant: Jeremy J. Burgess, SR., Las Vegas, NV (US)

(72) Inventor: Jeremy J. Burgess, SR., Las Vegas, NV (US)

(21) Appl. No.: 14/984,894

(22) Filed: Dec. 30, 2015

(51) Int. Cl. F16L 9/12; F16L 41/02; F16L 23/16

(52) U.S. Cl. CPC F16L 9/12; F16L 23/16; F16L 41/021; F16L 41/023

(57) ABSTRACT

A polymer piping assembly comprises polymer pipes interconnecting into a drain-waste-vent system. The polymer pipe is fabricated from a polymer, such as polyvinyl chloride. The polymer pipe is effective for joining with at least one metal pipe in the drain-waste-vent system. The polymer pipe includes a longitudinal length, at least one deviation, a cavity, and at least two termini. The pipe termini have a small terminal lip rather than a hub. The lip has a substantially smaller flare than the hub facilitating coupling to other polymer or metal pipes. The polymer pipe has substantially the same diameter as metal pipes for facilitated coupling to metal pipes. A coupling portion encompasses the termini of adjacent pipes. The coupling portion includes an outer shield, an inner gasket having a protruding ridge. At least one fastener tightens and loosens the coupling portion around the pipe termini.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

An embodiment of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to a polymer piping assembly for drain-waste-vent drainage system. More particularly, the invention relates to a polymer piping assembly that utilizes polyvinyl chloride pipes having a small terminal lip, rather than a hub or bell, and dimensioned in substantially the same diameter as metal pipes, such as but not limited to cast iron, to operatively interconnect with plumbing fixtures and metal pipes used in a drain-waste-vent drainage system.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that plumbing involves the fitting, cutting, and interconnection of multiple pipes into an overall network of pipes. Frequently during any plumbing job, it is necessary to make a lateral pipe connection between two substantially vertical pipes the ends of which are separated from each other by an unknown linear distance and angle.

Generally, the drain line from a shower, bath tub, toilet and/or sink are in fluid communication with a vent pipe that typically terminates above the roof of a building. This requires that a hole, roughly matching the diameter of the vent pipe, be drilled in the roof so that the plumbing system vents to the sky. Typically, the conventional vent pipe is fluidly communicating with the drain pipe of a sink. Many pieces of metal pipe and metal pipe fittings are necessary to plumb the system.

Typically, the joinder of the thermoplastic pipes has involved the use of solvents or the melting of one or both of the pieces of plastic and the immobilization of the pieces of plastic in the desired relationship to each other for fusion of the elements. Where plastic conduit was desired to be joined in fluid tight relationship, this has taken the form of heating of tubular ends and socket ends, joinder thereof, and immobilization in a jig or the like for 20-90 seconds while awaiting for the fusion to take place.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate views of an exemplary polymer pipe assembly, where FIG. 1A is a side perspective view of an exemplary elbow polymer pipe, and FIG. 1B is an upper angle perspective view of an exemplary elbow polymer pipe, in accordance with an embodiment of the present invention;

FIGS. 2A and 2B illustrate views of an exemplary polymer pipe assembly, where FIG. 2A is a side perspective view of an exemplary wye tee polymer pipe, and FIG. 2B is an upper angle perspective view of an exemplary wye tee polymer pipe, in accordance with an embodiment of the present invention;

FIG. 3 is a top view of an exemplary shielded coupling portion, in accordance with an embodiment of the present invention;

FIGS. 4A and 4B illustrates perspective views of an exemplary straight polymer pipe joining with an elbow polymer pipe assembly, where FIG. 4A shows the straight polymer pipe, the coupling portion, and the elbow polymer pipe, and FIG. 4B shows the straight polymer pipe joined with the elbow polymer pipe joined through the coupling portion, in accordance with an embodiment of the present invention;

FIG. 5 illustrates a perspective view of a wye tee polymer pipe joined with a metal pipe through a coupling portion, in accordance with an embodiment of the present invention; and

FIG. 6 illustrates a perspective view of an elbow polymer pipe joined with a metal pipe through a coupling portion, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of plumbing piping assemblies that may be provided by preferred embodiments of the present invention. In one embodiment of the present invention, a polymer piping assembly utilizes polymer pipes that are configured to interconnect with a drain-waste-vent drainage system, commonly used for carrying a liquid and venting pressure for plumbing. The polymer piping assembly, hereafter, “assembly” comprises at least one polymer pipe fabricated from a polymer, such as polyvinyl chloride (PVC). The polymer pipe may be especially effective for joining with at least one metal pipe in the drain-waste-vent drainage system.

In some embodiments, the at least one polymer pipe may include a longitudinal length, at least one deviation, a cavity, and at least two termini. The at least two termini may be configured with a small terminal lip rather than a hub. The lip has a substantially smaller flare than the hub that is used in the art of pipes. The lip facilitates coupling the polymer pipe to other polymer pipes or metal pipes. Further, the at least one polymer pipe may be dimensioned to have substantially the same diameter as metal pipes for coupling to existing metal pipes, such as iron pipes found in drain-waste-vent drainage systems.

In some embodiments, the at least one pipe of the assembly may include at least one of the following formations: elbows, wye tees, straight pipe, sweeps, bends, combo-T, sanitary-T, sanitary cross, and Y-fittings. In any shape, the polymer pipe is fabricated from a polymer, has a small lip, rather than a hub at the termini.

In some embodiments, a coupling portion may joinder two termini of polymer pipe together. Though in other embodiments, the coupling portion may joinder a polymer pipe with a metal pipe. The coupling portion may have a generally circular shape configured to encompass the termini of the polymer pipe and/or metal pipe.

In some embodiments, the coupling portion comprises an outer shield and an inner gasket that engages the termini of the polymer and/or metal pipes. A ridge may protrude from the inner gasket to create a seal at the junction between pipe termini. At least one fastener may tighten and loosen the coupling portion around the junction between the pipes.

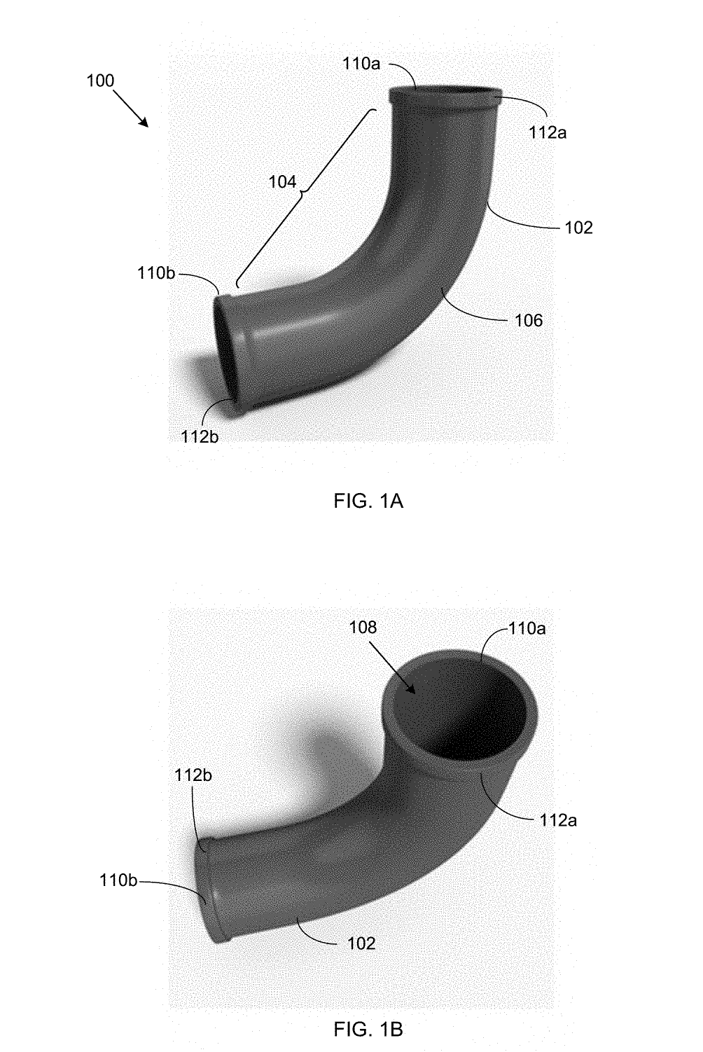

FIGS. 1A and 1B illustrate views of an exemplary polymer pipe assembly, where FIG. 1A is a side perspective view of an exemplary elbow polymer pipe, and FIG. 1B is an upper angle perspective view of an exemplary elbow polymer pipe, in accordance with an embodiment of the present invention. In one aspect, a polymer piping assembly 100 is integrated into a drain-waste-vent drainage system. The polymer piping assembly, hereafter, “assembly”, may include at least one polymer pipe 102 that is configured to interconnect with other polymer pipes, metal pipes, and plumbing fixtures. In one embodiment, the assembly is integrated into a drain-waste-vent drainage system known in the art to carry a liquid or waste, and venting excess air pressure. The polymer pipe may join with at least one metal pipe in the drain-waste-vent drainage system. Though, in some embodiment, any piping system that is not under pressure may utilize the polymer piping assembly.

Those skilled in the art will recognize that many plumbing codes do not allow solvent welding of polyvinyl chloride (PVC) pipes to acrylonitrile butadiene styrene (ABS) pipes. The polymer piping assembly allows the connection of such PVC pipes and ABS pipes by allowing an alternate, and much improved, format of their attachment. In one possible embodiment, the assembly may be configured to meet or exceeds the relevant minimum standards and requirements of the Uniform Plumbing Code (UPC), the American Water Works Association (AWWA), the National Sanitation Foundation (NSF) and the American Society for Testing and Materials (ASTM).

The assembly comprises at least one polymer pipe fabricated from a polymer, such as PVC. Though in other embodiments, the polymer pipe may use alternates to PVC, including, without limitation, chloro-polyvinyl chloride (CPVC), acrylonitrile butadiene styrene (ABS), high-density polyethylene (HDPE), and thermoplastics. Other plastics that may be used may include, without limitation, Polypropylene, Eastman Tritan™ copolyester, and Polyethylene Terephthalate (PET).

As illustrated in FIGS. 1 A and 1B, the elbow polymer pipe may include a longitudinal length 104, at least one deviation 106, a cavity 108, and at least two termini 110a, 110b. The at least two termini may be configured with a small terminal lip 112a, 112b, rather than a hub. The lip has a substantially smaller flare than the hub that is used in the art of pipes. The lip may facilitate coupling the polymer pipe to other polymer pipes or metal pipes. Further, the at least one polymer pipe may be dimensioned to have substantially the same diameter as metal pipes for coupling to existing metal pipes, such as iron pipes found in drain-waste-vent drainage systems. The dimensions of the lip may be approximately ⅛″ tall×⅛″ broad.

In some embodiments, the at least one pipe of the assembly may include at least one of the following formations: elbows, wye tees, straight pipe, sweeps, bends, combo-T, sanitary-T, sanitary cross, and Y-fittings. These formations may join together or with a metal pipe. The metal pipe may include an iron pipe, known in the art of plumbing, and having similar formations as those described above. However, in any shape, the polymer pipe is fabricated from a polymer, and has a small lip, rather than a hub at the termini. For example, the longitudinal length of the elbow polymer pipe illustrated in FIGS. 1A and 1B forms an arc of about 90°. Though in other embodiments, a 45° angle may be formed. The two termini have a lip. The lip enables connections to be made without requiring solvent welding.

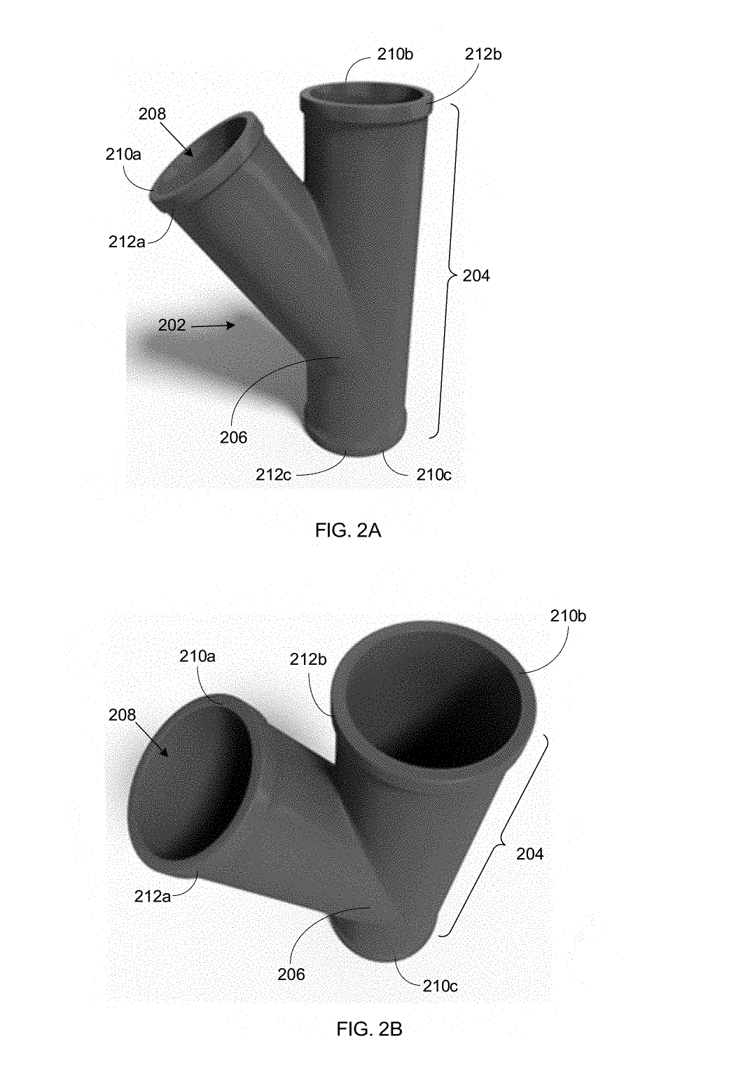

FIGS. 2A and 2B illustrate views of an exemplary polymer pipe assembly, where FIG. 2A is a side perspective view of an exemplary wye tee polymer pipe, and FIG. 2B is an upper angle perspective view of an exemplary wye tee polymer pipe, in accordance with an embodiment of the present invention. In one aspect, a wye tee polymer pipe 202 has two longitudinal lengths 204 that run at an angle to each other. The wye tee also has a deviation 206 medially located at the longitudinal length. A pair of cavities 208 are formed. The wye tee polymer pipe further includes at least two termini 210a, 210b, 210c. The at least two termini may be configured with a small terminal lip 212a, 212b, 212c rather than a hub. The lip has a substantially smaller flare than the hub that is used in the art of pipes. The polymer pipes and/or metal pipes are joined with a coupling portion, described below.

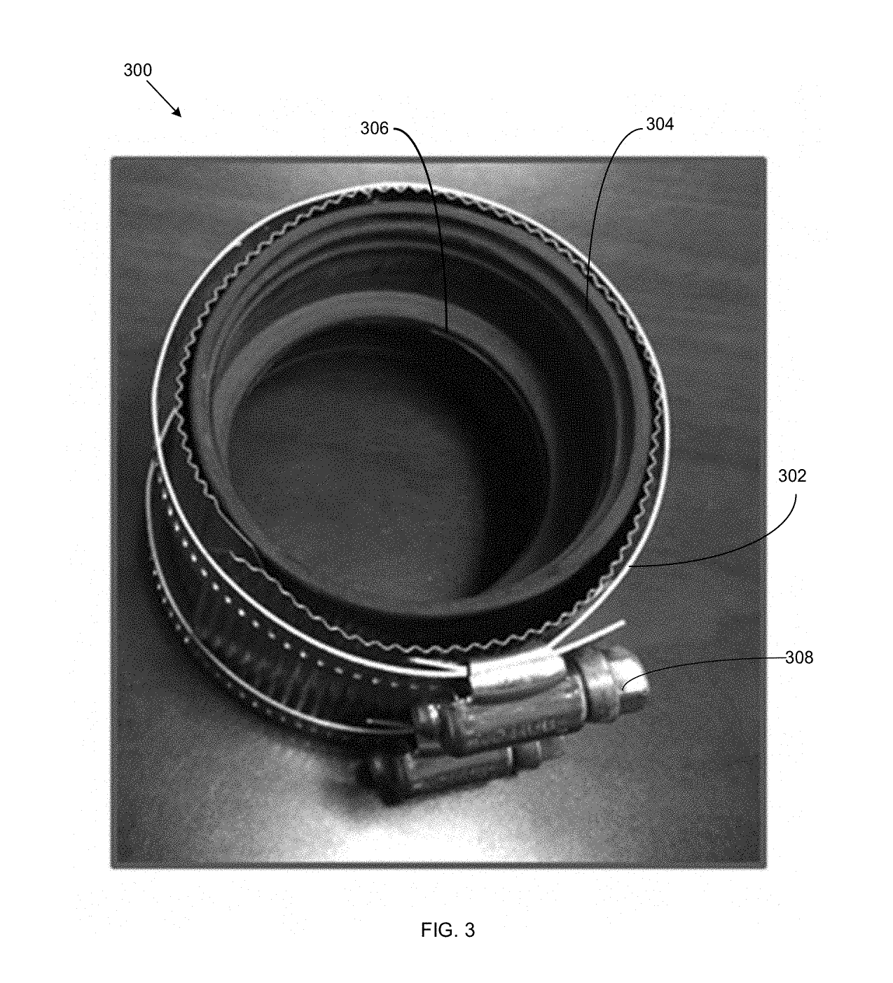

FIG. 3 is a top view of an exemplary coupling portion, in accordance with an embodiment of the present invention. In one aspect, a coupling portion 300 may joinder two termini of polymer pipe together. Though in other embodiments, the coupling portion may joinder a polymer pipe with a metal pipe. The coupling portion may have a generally circular shape configured to encompass the termini of the polymer pipe and/or metal pipe. The circular shape conforms to the diameter of the polymer pipe, and especially the termini, where the joinder occurs.

In some embodiments, the coupling portion comprises an outer shield 302 and an inner gasket 304 that engages the termini of the polymer and/or metal pipes. A ridge 306 may protrude from the inner gasket to create a seal at the junction between pipe termini. At least one fastener 308 may tighten and loosen the coupling portion around the junction between the pipes.

The outer shield may be fabricated from various materials of applicability and code-acceptability, such as but not limited to, stainless steel and aluminum alloy. The at least one fastener may include, without limitation worm clamps, screws, tension springs, and bolts. The fastener adjusts the compression of the coupling portion around the diameter of the termini.

The interior gasket may have a consistent diameter of flexibility, pending on its capability to ensure firm sealing upon piping segments that have differing exterior diameters. However in other embodiments, the interior gasket may be capable of two different diameters of flexibility in order to accommodate placement on such pipe segments. The inner gasket may be fabricated from various materials of applicability and code-acceptability, such as but not limited to neoprene, polyurethane (PU), and polytetrafluroethylene (PTFE).

Because the coupling portion creates a mechanical attachment, rather than solvent welding used in the art, the replacement of older, damaged metal pipes is possible without requiring complete replacement of the entire drain-waste-vent system. Furthermore, unlike solvent welded PVC, the coupling portion allows the polymer pipes to be dismantled, replaced, and changes made to pipe layout without need to cut out and dispose of material.

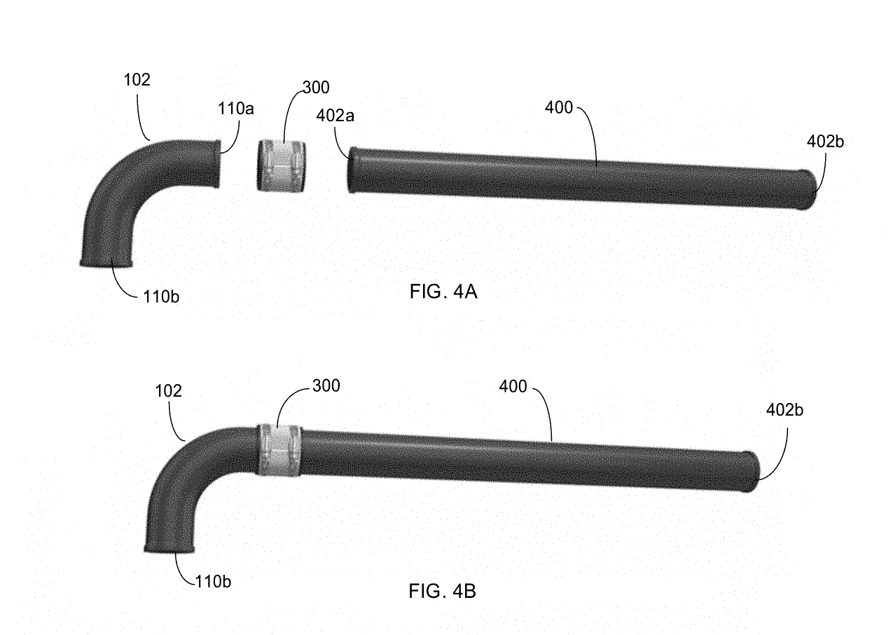

FIGS. 4A and 4B illustrates perspective views of an exemplary straight polymer pipe joining with an elbow polymer pipe assembly, where FIG. 4A shows the straight polymer pipe, the coupling portion, and the elbow polymer pipe, and FIG. 4B shows the straight polymer pipe joined with the elbow polymer pipe joined through the coupling portion. In one aspect, a straight polymer pipe 400 joins with the elbow polymer pipe described above. The straight polymer pipe has a pair of termini 402a, 402b that join with a corresponding terminus of the elbow polymer pipe. The lip at the end of teach termini engage each other, as the coupling portion forms a tight seal between the termini.

It is significant to note that the polymer composition of the straight and elbow polymer pipes may allow the assembly to exhibit unique characteristics that are useful for plumbing, including being pipe corrosion-resistant to most acids, salts, oxidants, halogens, aliphatic solutions, and salts.

In some embodiments, the at least one polymer pipe may be marked for identification purposes, by printing or embedding, various information, such as but not limited to standard dimension ratio (SDR), pressure class, material type, and/or an image or logo identifying its manufacturer, which may or may not be of registered trademark and/or copyright status.

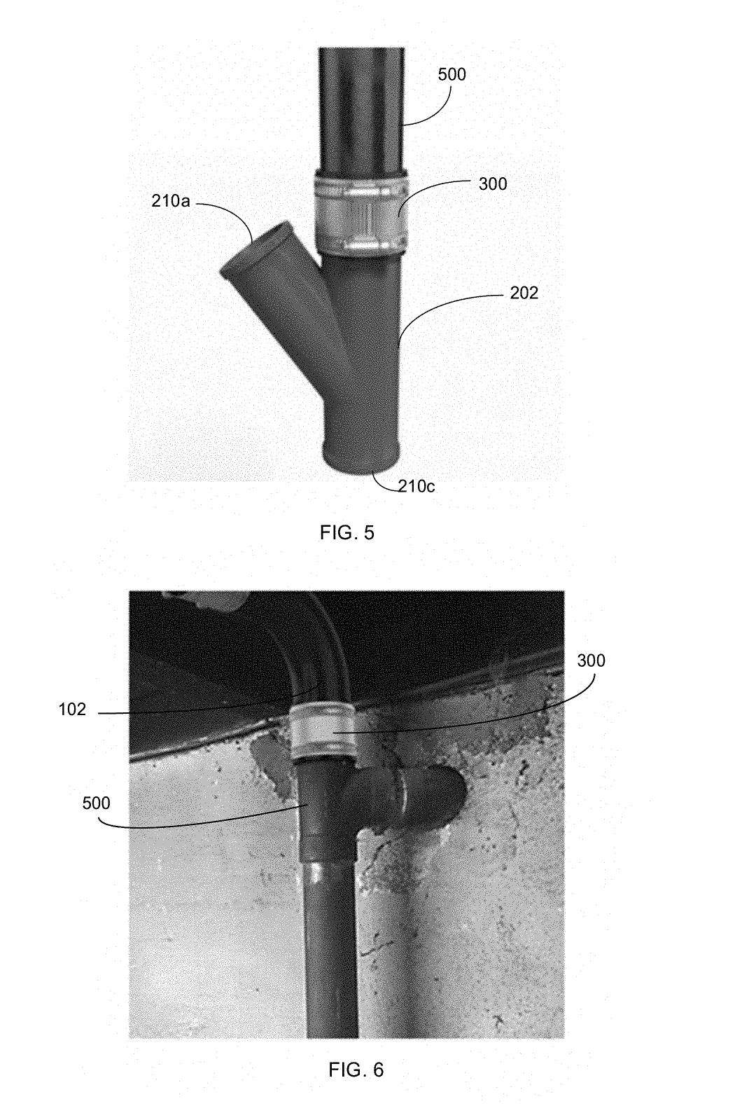

FIG. 5 illustrates a perspective view of a wye tee polymer pipe joined with a metal pipe through a coupling portion, in accordance with an embodiment of the present invention. In one aspect, the assembly is especially effective when integrated in a drain-waste-vent drainage system that uses at least one metal pipe 500. The drain-waste-vent drainage system removes sewage and greywater from a building, and regulates air pressure in the waste-system pipes to aid free flow. It is known in the art that waste is produced at fixtures such as toilets, sinks, and showers, and exits the fixtures through a trap, which is a dipped section of pipe that always contains water. Most drain-waste-vent drainage systems use metal pipes, and specifically, iron pipes.

The polymer pipe is effective in integrating with the metal pipes of the drain-waste-vent drainage system because the termini of the polymer pipes have a diameter that substantially matches the diameter of the metal pipes used in drain-waste-vent drainage systems. By not having a hub that flares out, the connection with metal pipes is more easily achieved. Further, the use of polymer pipes eliminates the need to use expensive metals when replacing old metal pipes. The lighter weight of the polymer pipe in comparison to metal pipes also aids faster production, and substantially reduces the risks of workplace injuries.

FIG. 6 illustrates a perspective view of an elbow polymer pipe joined with a metal pipe through a coupling portion, in accordance with an embodiment of the present invention. In one aspect, the elbow polymer pipe shown in FIG. 6 replaces a segment of metal pipe. In this exemplary embodiment, the elbow polymer pipe is a segment of piping made of PVC in a 2″ interior diameter. The elbow polymer pipe is produced in a reddish-brown color.

Further, the outer shield of the coupling portion is made of stainless steel, and features two hex screws for insertion within apertures that, when the screws are tightened, restricts the diameter of the outer shield for firm attachment upon the separate segments of polymer and metal pipes to which it is applied. The interior gasket of the coupling portion is made of neoprene, and with a flexibility that allows firm and securing attachment to other segments of the drain-waste-vent drainage systems.

In one alternative embodiment, the polymer pipe may have a polymer alloy that allows the polymer pipe to be flexible. In yet another alternative embodiment, the polymer piping assembly is operable in an oil refinery, a ventilation system, a water purification system, or any complex system requiring piping. In yet another alternative embodiment, the coupling portion is fabricated from PVC.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the data portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which data portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a polymer piping assembly that interconnects with metal pipes and metal fixtures according to the present invention will be apparent to those skilled in the art. Various aspects of the invention have been described above by way of illustration, and the specific embodiments disclosed are not intended to limit the invention to the particular forms disclosed. The particular implementation of the polymer piping assembly that interconnects with metal pipes and metal fixtures may vary depending upon the particular context or application. By way of example, and not limitation, the a polymer piping assembly that interconnects with metal pipes and metal fixtures described in the foregoing were principally directed to a polymer piping assembly that utilizes polymer pipes and fittings having a small terminal lip, rather than a hub, and dimensioned in substantially the same diameter as metal pipes to operatively interconnect with plumbing fixtures and metal pipes used in a drain-waste-vent drainage system; however, similar techniques may instead be applied to piping air or other fluids, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An assembly comprising:
at least one polymer pipe, said at least one polymer pipe defined by a substantially polymer composition, said at least one polymer pipe comprising a longitudinal length, said at least one polymer pipe further comprising at least one deviation, said at least one polymer pipe further comprising a cavity, said at least one polymer pipe further comprising at least two termini, said at least two termini comprising a lip; and
a coupling portion, said coupling portion being configured to enable at least partial joining of said at least one polymer pipe to an adjacent polymer pipe, said coupling portion further being configured to have an adjustable diameter for at least partially encompassing said at least two termini of said at least one polymer pipe and an adjacent terminus of said adjacent polymer pipe, said coupling portion comprising an outer shield, said outer shield being configured to help protect said junction between said at least one polymer pipe and said adjacent polymer pipe, said coupling portion further comprising an inner gasket having a ridge, said ridge being configured to engage said lip of said at least two termini for at least partially forming a seal between said at least one polymer pipe and said adjacent polymer pipe.

2. The assembly of claim 1, wherein said at least one polymer pipe includes at least one member selected from the group consisting of: elbows, wye tees, straight pipe, sweeps, bends, combo-T, sanitary-T, sanitary cross, and Y-fittings.

3. The assembly of claim 2, wherein said at least one polymer pipe is fabricated from at least one member selected from the group consisting of: polyvinyl chloride, chloro-polyvinyl chloride, acrylonitrile butadiene styrene, and high-density polyethylene.

4. The assembly of claim 3, wherein said at least one deviation is configured to create an angle along said longitudinal length.

5. The assembly of claim 4, wherein said lip at said at least two termini is configured to replace a hub.

6. The assembly of claim 5, wherein said at least one polymer pipe has a two inch inner diameter.

7. The assembly of claim 6, wherein coupling portion has a generally cylindrical shape.

8. The assembly of claim 7, wherein outer shield is aluminum.

9. The assembly of claim 8, wherein said inner gasket is neoprene material.

10. The assembly of claim 9, wherein said ridge encircles a median region of said inner gasket.

11. The assembly of claim 10, further including at least one fastener.

12. The assembly of claim 11, wherein said at least one fastener is configured to help tighten and loosen said coupling portion around said at least two termini of said at least one polymer pipe and said adjacent terminus of said adjacent polymer pipe.

13. The assembly of claim 12, wherein said at least one fastener is a hex screw.

14. The assembly of claim 13, wherein said coupling portion comprises an aperture, said aperture being configured to receive said at least one fastener.

15. The assembly of claim 14, wherein said at least one polymer pipe is configured to join with at least one metal pipe.

16. The assembly of claim 15, wherein said at least one polymer pipe has a diameter substantially the same as said at least one metal pipe.

17. The assembly of claim 16, wherein said at least one polymer pipe joins with said at least one metal pipe through said coupling portion.

18. The assembly of claim 17, wherein said assembly is configured to integrate into a drain-waste-vent drainage system.

19. An assembly comprising:
means for carrying a fluid;
means for joining said carrying means with an integrated carrying means configured to carry said fluid;
means for sealing said carrying means and said integrated carrying means together;
means for coupling said carrying means with said integrated carrying means; and
means for fastening said carrying means to said integrated carrying means.

20. An assembly consisting of:
at least one polyvinyl chloride pipe, said at least one polyvinyl chloride pipe defined by a substantially polyvinyl chloride composition, said at least one polyvinyl chloride pipe comprising a longitudinal length, said at least one polyvinyl chloride pipe further comprising at least one deviation, said at least one polyvinyl chloride pipe further comprising a cavity, said at least one polyvinyl chloride pipe further comprising at least two termini, said at least two termini comprising a lip;
a coupling portion, said coupling portion being configured to enable at least partial joining of said at least one polyvinyl chloride pipe to an adjacent polyvinyl chloride pipe, said coupling portion further being configured to have an adjustable diameter for at least partially encompassing said at least two termini of said at least one polyvinyl chloride pipe and an adjacent terminus of said adjacent polyvinyl chloride pipe, said coupling portion comprising an outer shield, said outer shield being configured to help protect said junction between said at least one polyvinyl chloride pipe and said adjacent polyvinyl chloride pipe, said coupling portion further comprising an inner gasket having a ridge, said ridge being configured to engage said lip of said at least two termini for at least partially forming a seal between said at least one polyvinyl chloride pipe and said adjacent polyvinyl chloride pipe; and
at least one fastener, said at least one fastener being configured to help tighten and loosen said coupling portion around said at least two termini of said at least one polyvinyl chloride pipe and said adjacent terminus of said adjacent polyvinyl chloride pipe.
